(19) United States
(12) Patent Application Publication
(10) Pub. No.: US 2010/0135515 A1
(43) Pub. Date: Jun. 3, 2010

(54) HEADPHONES

(75) Inventor: Duncan Christopher Walsh, Buxton (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: MI-SPORT GLOBAL LIMITED, Nottingham (GB)

(21) Appl. No.: 12/598,853

(22) PCT Filed: May 6, 2008
(86) PCT No.: PCT/GB08/01570

§ 371 Date: Feb. 10, 2010

(30) Foreign Application Priority Data
May 4, 2007 (GB) 0708664.8

(51) Int. Cl. H04R 25/00; G06F 17/00

(52) U.S. Cl. 381/374; 700/94

(57) ABSTRACT

A headphones arrangement comprising an ear piece arranged to accommodate at least a part of an audio player and storage device therein along with a loud speaker, the housing incorporating a peripheral seal as an effective moisture barrier to ingress of moisture within the housing.

The present invention relates to headphones and more particularly headphones incorporating an integral audio player and storage device such as an MP3 player.

Conventional music player and storage devices have become increasingly transportable to enable such devices to be carried by a user. Music player and storage devices are commonly referred to as MP3 players and are available under such trade marks as the Apple IPOD, Sony Walkman etc. These devices generally are relatively small in size so that they can be carried in a pocket or strapped in use upon the arm of user or carried as a pendent. For increasing convenience particularly when performing vigorous exercise it is desirable to provide a headset which can be associated with the player device so that the user receives the benefits of music downloads without disturbing their neighbours. There is typically a physical wire connection between the player device and the headset or a wireless connection such as a Bluetooth® connection between the player device and the headphones.

More recently, music player and storage devices have been incorporated within the headphones themselves and in particular in ear pieces of those headphones or headsets. In such situations the inconvenience of wire or potential breaks in communication with wireless couplings with a player device secured on a strap or in a pocket is avoided.

Integration of a music player and storage device within a headset requires a degree of miniaturisation and compromises in the view of the smaller space available. It should be appreciated that music player and storage devices incorporate appropriate circuitry to play music downloads as well as an electronic memory store for downloads, a battery to provide independent power for the music player and storage device and speakers along with ancillary apparatus. There is limited space available within ear piece assemblies and a band is provided to extend between the ear pieces to provide a bias to embrace a user's head.

One of the advantages with regard to providing an integrated music player and storage device in a headset is to avoid the inconvenience of wires and interruptability of wireless connections. Such benefits are particularly important when involved in sporting activity such as playing squash or running. Nevertheless, such sporting activities mean that the headsets will be exposed to high levels of sweat with degradation and problems with moisture ingress to the ear pieces. The ingress of moisture will shorten the operational life of the headset and undermine reliability. Conventional passive or dummy headsets which simply connect through to an MP3 player are sufficiently cheap to be disposable. Integrated headsets with the MP3 player incorporated will be considerably more expensive and therefore short lifetimes will be unacceptable.

In accordance with aspects of the present invention there is provided a headphones arrangement comprising an ear piece arranged to accommodate at least a part of an audio player and storage device therein along with a loud speaker, the housing incorporating a peripheral seal as an effective moisture barrier to ingress of moisture within the housing.

Typically, the headphones also incorporate a connector seal for an electrical connector port to the player and storage device.

Generally, the audio player and storage device is an MP3 player.

Typically, the headset comprises a pair of ear piece housings connected by a band to bias in use engagement by the headphones about a user's head.

Generally, the housing comprises housing parts secured together along abutting edges. Typically, the peripheral seal engages between the abutting edges. Typically, the peripheral seal comprises a flat washer or O ring. Generally, the peripheral seal is formed from a silicon rubber material. Possibly, the abutting edges include a gutter channel for moisture evacuation.

Generally, the connector seal comprises a slit flap or doughnut constriction across the electrical port. Typically, the slit flap or doughnut constriction is made from a silicon rubber material.

Generally, the loud speaker is waterproof.

Possibly, the ear piece is coated with a waterproof film or lacquer. Possibly, the waterproof film or lacquer is located over seams of the ear piece.

Generally, the headset incorporates button switches having a seal across the button. Possibly, the button is a diaphragm button.

Possibly, an ear phone chassis includes an aperture to allow air pressure balance in use.

An embodiment of headphones in accordance with aspects of the present invention will now be described by way of example and with reference to the accompanying drawings in which;

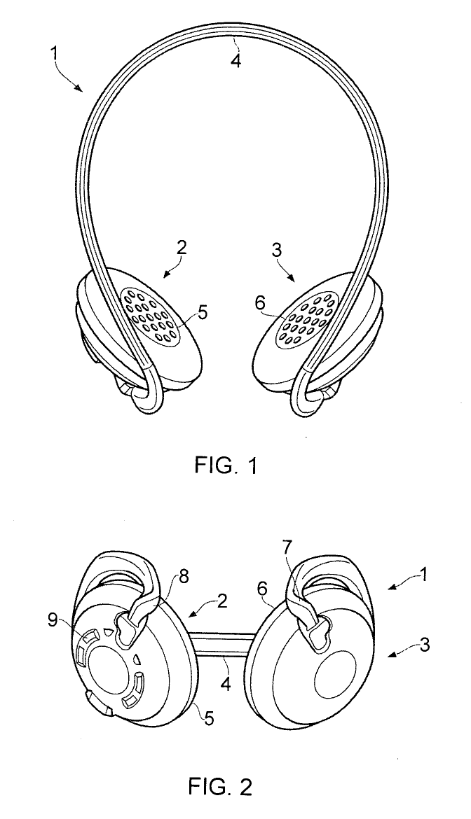

FIG. 1 is a front view of headphones in accordance with aspects of the present invention;

FIG. 2 is side view of the headphones depicted in FIG. 1;

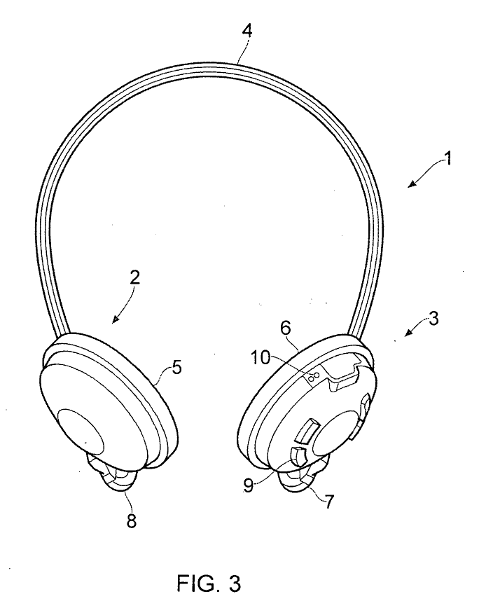

FIG. 3 is a rear perspective view of the headphones depicted in FIGS. 1 and 2;

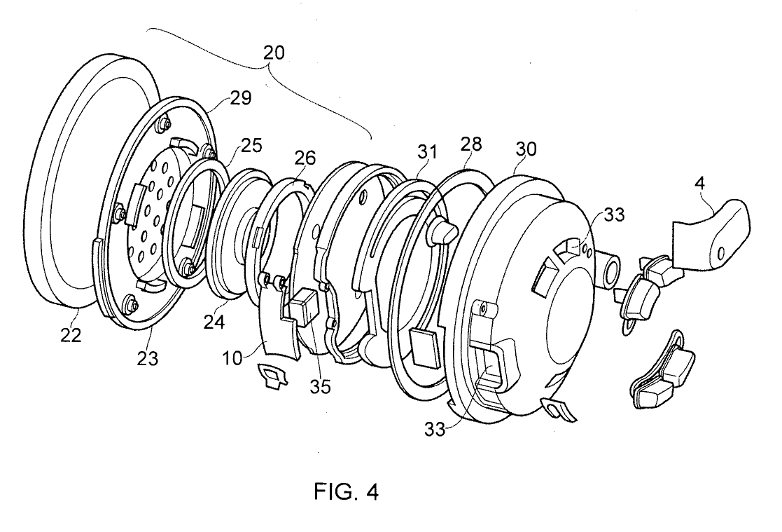

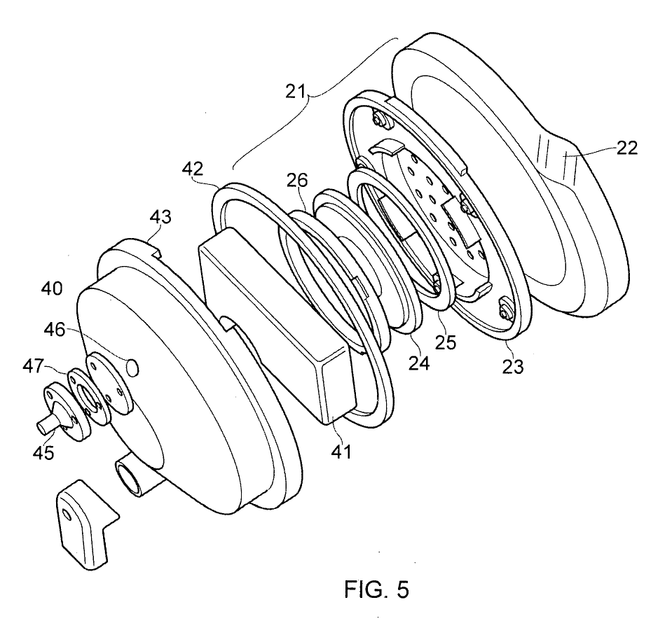

FIG. 4 is an exploded view of one ear piece of the headphones depicted in FIGS. 1 to 3;

FIG. 5 is an exploded view of the other ear piece of the headphones depicted in FIGS. 1 to 3; and

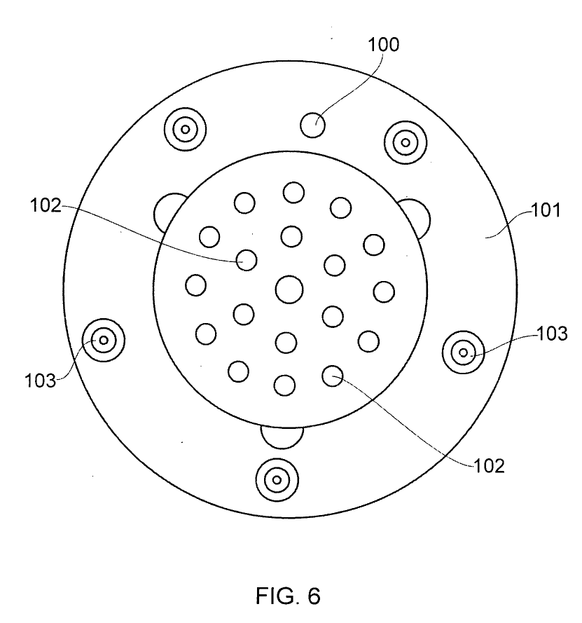

FIG. 6 is a front view of an ear piece element in accordance with further aspects of the present invention.

The shape and configuration of headphones to a significant extend are dictated by normal user dimensions. It will be appreciated that the headphones must be able to be retained about a user's head and typically will incorporate ear hooks and/or a bias band to extend between ear pieces such that the ear pieces are compressed inwardly to engage a user's head.

FIG. 1 shows a front view of headphones 1 in accordance with aspects of the present invention. Thus, as is conventional ear pieces 2, 3 are presented upon a band 4 with an inward bias to engage a user's ears (not shown). The band 4 is arranged to be tensioned when engaging a user's head to provide the compressive bias to push the ear pieces 2, 3 towards the users' ears. The band 4 also allows electrical connections between the ear pieces such that the ear pieces 2, 3 may accommodate respective parts of the music player and storage device (e.g. MP3 player). As indicated above generally these parts include the electronics of the player device as well as an electronic storage device and batteries along with loud speakers 5, 6. The respective parts of the player may allow playing of stored audio music as well as use of a radio receiver.

FIG. 2 provides a side perspective view of the headphones 1 depicted in FIG. 1. Thus, each earpiece 2, 3 as indicated previously is connected to the band 4 through an appropriate elbow junction 7, 8 which presents the ear piece 2, 3 in use. The band 4 and elbow junctions 7, 8 are configured and formed from material in order to provide the necessary bias towards the user with respect to retention of positioning the ear pieces 2, 3. For convenience of use without a need for sight review at least one of the ear pieces 2 incorporates relatively large buttons 9 such that the headphones 1 can be operated without removing them from the user's head. For example, one button may be simply arranged to shuffle forwards the music or other downloads stored within the headset whilst another button skips back over a range of available downloads. Other buttons may simply switch the headset ON and OFF.

FIG. 3 illustrates the headphones 1 depicted in FIGS. 1 and 2. As indicated above headphones in accordance with aspects of the present invention will be an integral unit. In such circumstances all functions will be provided within the headphones 1. These functions include the necessary electronics and storage facilities as well as a battery to power the music player and storage device in use. Thus, as indicated previously a number of buttons and configurational details with regard to the headphones are provided to enable use. However, it will be understood that the audio player and storage device must be able to download music or other audio recordings to the storage device. In such circumstances one of the ear pieces 2 will incorporate an appropriate electrical port. Aspects of the present invention provide headphones which are resistant to moisture penetration. In such circumstance the electrical port will typically be located behind a flap 10 which will act in concert with a connector seal to prevent moisture ingress into the housing providing the ear piece 2.

Aspects of the present invention provide an integral music player and storage device within headphones. Thus, the ear pieces 2, 3 of the headphones will include the circuitry for the player associated with electrical connections to allow downloading of audio content to a storage device. The headphones will also incorporate loud speakers or a similar device to allow audio reproduction of the stored audio message or download. In accordance with aspects of the present invention the headphones are designed to be sufficiently waterproof to meet expected operational requirements. In such circumstance all orifices and seams are appropriately sealed. Thus, all buttons have seals, the electrical ports have seals and the housing parts providing the ear pieces 2, 3 are appropriately sealed to prevent or at least inhibit ingress of liquids and moisture. The electrical port or USB will generally be as indicated above located behind a flap 10 which is displaceable to allow access but in normal use is contiguous with the remainder of the housing. Generally the loud speakers utilised in each ear piece 2, 3 of the headphones will be coated with an appropriate waterproof sealant to act in addition to base sealing elements utilised within the headphones. Generally the headphones will not be completely waterproof as this will potentially cause the headphones to be too cumbersome for operational use. The headphones will be designed to allow emersion or dunking in liquids for short periods of time without significant moisture penetration.

Headphones in accordance with aspects of the present invention will maintain necessary functionality with regard to an audio player and storage of downloads consistent with expected performance of such devices. The electronic components for these functional elements may be located in one ear piece or more typically elements of the necessary circuitry and electronic storage device will be located or distributed between the housings provided for both ear pieces. In such circumstance each ear piece will include at least one part of the audio player and storage device so utilising most efficiently available space in the respective ear piece housings. FIGS. 4 and 5 respectively show the ear pieces 2, 3 in accordance with aspects of the present invention illustrated in FIGS. 1 to 3.

It will be noted in order to provide a stereo facility each ear piece 2, 3 will have a respective loud speaker assembly 20, 21.

Referring to FIG. 4 as can be seen the loud speaker assembly 20 comprises an ear engagement mesh 22 presented upon a loud speaker chassis 23 to which the appropriate loud speaker mechanism 24 is secured. In accordance with aspects of the present invention a loud speaker seal 25 is provided between the chassis 23 and the loud speaker mechanism 24. It will be appreciated that the loud speaker mechanism 24 is the most sensitive element of the loud speaker assembly 20 and will typically incorporate electronic connections susceptible to damage by moisture but by provision of the seal 25 such moisture ingress is at least inhibited. Furthermore, the mesh 20 along with the chassis 23 will incorporate coatings as well as aperture sizes which through surface tension will inhibit moisture ingress. The mechanism 24 will also be presented upon a further seal 26 and suspension mechanism to allow loud speaker operations. The seal 26 will further provide and inhibit moisture transmission through the housing assembly of the ear piece 2.

A peripheral seal 28 engages peripheral parts of the housing part 27 as well as the chassis 23 across peripheral abutment edges 29, 30. The peripheral seal 28 will act as a primary moisture inhibitor with regard to ingress into the interior of the ear piece 2. Within the ear piece 2 further seals 31 may also be provided as secondary and further inhibitors of moisture transferred.

As indicated above the loud speaker assembly 20 will be configured to inhibit moisture ingress as indicated through the peripheral seal 28 and further seals 31. It will be understood that parts of the ear piece 20 are effectively compartmentalised and each compartment designed to inhibit moisture transfer. Nevertheless, for control of the head piece and in particular the player device within that head piece buttons must be provided. These buttons will generally be of a press type. In such circumstance apertures 32, 33 will be formed within the ear piece 2 and in particular the housing part 27. In accordance with aspects of the present invention these apertures are sealed utilising sealing members.

It will be understood that the band 4 is secured to the ear piece through an appropriate mounting 34. Generally, the mounting 34 will be arranged so that it does not penetrate through the housing part 27 to avoid breaking the seal barrier but provides good global location.

The aperture 32 will provide location mountings for the electrical connector port 35. As described previously generally a flap 10 will be located over the aperture 32 to act in concert with a connector seal. The connector seal generally comprises a slit seal or doughnut seal constriction. A slit seal with comprise a layer of appropriate sealant material such as silicon rubber which incorporates a slit for location directly over the electrical connector duct. In such circumstances, when the connector jack is pushed towards the electrical connector duct it will push through the slit and therefore enter the electrical connector duct. Once the electrical connector jack is removed the slit will return to its original position necessary through a shaped memory facility such that the lips of the slit close in order to inhibit moisture transfer. A doughnut constriction will comprise a ring of sealant material again typically a silicon rubber which in a relaxed state extends to close the doughnut. Upon entry of a connector jack the doughnut is expanded to allow access to the electrical duct whilst on jack retraction the doughnut constricts to close access and therefore inhibit moisture transfer.

The seals 25, 28, 31 and connector seals utilised with regard to the aperture 32 as indicated will generally be formed from a silicon rubber or similar material. It will also be understood that where appropriate waterproof adhesives will be utilised along seams and edges within the ear piece 2 to further inhibit moisture transfer. With regard to apertures 33 as indicated these will typically allow buttons to engage circuitry within the ear piece 2. As previously appropriate seals can be provided for the buttons or the buttons themselves will be of a diaphragm type such that the apertures 33 are effectively closed.

The seals utilised with regard to ear piece 2 as indicated are principally there to inhibit moisture transfer to the interior electronics of the headphones. In order to enhance this functionality the ear piece 2 may be further waterproofed by spray application of a waterproofing coating or dubbing. Such waterproofing may be sprayed upon the ear piece 2. It will be appreciated that a spray coating will wear and rub away breaking the waterproofing function. However, by use of these seals in accordance of the aspects of the present invention repeated application of spray waterproofing is more conveniently achieved. Spray waterproofing by implication typically requires use of a carrier fluid. The seals utilised in the general construction of the headphones will be sufficient to prevent such ingress by the carrier to the electronics within the ear piece 2. In such circumstances upon drying or evaporation of the carrier fluid the waterproofing function will remain as a thin coating about the ear piece. It will also be understood that the position of the seals in accordance with aspects of the present invention may allow ingress of some of the carrier into seams until barred by the seals. In such circumstances the carried waterproof materials may enter the seams and therefore reinforce waterproofing by structural seals in accordance with aspects of the present invention. Spray waterproofing may be repeatedly applied to the ear piece as required. Furthermore, as indicated headphones in accordance with aspects of the present invention will be particularly useful with regard to sports activities. In such circumstances deodorising sprays and cleaning can be more appropriately utilised with respect to the headphones with reduced possibility of damage. The deodorising sprays may be combined with the waterproofing spray.

FIG. 5 provides an exploded view of the ear piece 3 in accordance with aspect of the present invention. As indicated above the functional components of the audio player and storage device may be spread between the ear pieces 2, 3 but a respective loud speaker assembly 20, 21 is provided in each respective ear piece 2, 3. In such circumstances the loud speaker assembly 21 in ear piece 3 will be substantially the same as the loud speaker assembly 20 provided in ear piece 2. Similar reference numerals have therefore been used with regard to assembly 21 as assembly 20 for reference. The assembly 21 again incorporates a chassis 23 which acts as part of the housing combination with the housing part 40. The assembly 21 provides a compartment to inhibit moisture ingress into the ear piece 3. The mesh 22, seal 25 and seal 26 therefore act to prevent moisture access towards the electronic assembly 41 located within the housing comprising a housing part 40 and the chassis 23 of the ear piece 3 in accordance with aspects of the present invention. As previously a peripheral seal 42 acts between abutting edge 43, 44 of the ear piece 3 in order to inhibit moisture ingress. As previously the peripheral seal 42 acts as a primary inhibitor of moisture movement. However, it may be possible to provide through separate application or dipping a water barrier as a coating over the ear piece 3. This coating will be a thin film as indicated previously which may wear away but can be replaced periodically. Furthermore deodorising and cleansing can be more readily achieved with liquids by provision of the seal 42 allowing short term immersion or wetting for such actions.

The ear piece 3 in accordance with the embodiment depicted in the figures incorporates a button 45 which passes through an aperture 46 in order to control or actuate the electronic assembly 41. In accordance with aspects of the present invention a connector seal 47 is provided to again inhibit moisture transfer through the aperture 46.

It will be appreciated that the respective housings created by the housing parts 27, 40 and chassis 23 will be configured such that there is generally a compressive abutment between the edges 29, 30, and 43, 44 such that an adequate seal is provided by the peripheral seals 28, 42. This will generally be achieved through a fusion bond or through utilisation of an adhesive.

As indicated in accordance with aspects of the present invention headphones are provided which are particularly designed for utilisation by a user whilst performing strenuous sporting activities. In such circumstances the moisture which may ingress into the respective ear pieces 2, 3 will be sweat. The aggressiveness of the moisture in terms of volume and pressure will be variable and generally not excessive. In such circumstances by providing a peripheral drain guttering about the abutting edges 29, 30 and 43, 44 such sweat may be guided away from the seals 28, 42. Furthermore, as indicated in accordance with aspects of the present invention the guttering may be cleaned through immersion in water such that such drain gutters may provide means for guiding away water subsequent to immersion for cleaning.

The seals illustrated above with regard to FIGS. 4 and 5 are generally of a flat washer type configuration. However, alternatively the seals may comprise O rings or specifically shaped seals having ribs and edging in order to further enhance sealing performance.

The interiors of the ear pieces 2, 3 as indicated above provide a cavity in which within the electronic and electrical power sources are provided. Generally these electrical devices in operation may produce some heat. This heat may be utilised in order to generate a slight interior pressure and again acting with and upon the seals to inhibit moisture ingress within the ear pieces in accordance with aspects of the present invention.

It will be understood that acoustic quality will depend upon a number of factors including potential pressure differentials across the ear phone chassis accordance with aspects of the present invention. It will be understood that this chassis although retained within the waterproof area of the headphones may be subject to a pressure differential each side. This pressure differential may alter, muffle or distort sound reproduction by the loud speaker elements within the headphones. As illustrated in FIG. 6 an aperture 100 may be provided within a headphone chassis 101 in order to provide for pressure regulation and balance across the chassis 101. Thus, acoustic elements (not shown) acting through acoustic apertures 102 will not have any sound reproduction compromised by a pressure differential across the chassis 101. It will be noted that the chassis 101 as with previous arrangements is generally secured robustly through the attachments 103 about the periphery of the chassis 101. Such robust attachment will ensure with other elements as described above can be appropriately waterproof and a wet proof assembly is created.

Modifications and alterations to aspects of the present invention will be appreciated by those skilled in the art. Thus, for example the abutting edges 29, 30, and 43, 44 may include overlapping elements and inter-engagement sections in order to create a labyrinth seal barrier to moisture ingress.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A headphones arrangement comprising a housing arranged to accommodate at least a part of an audio player and storage device therein along with a loud speaker, the housing incorporating a peripheral seal as an effective moisture barrier to ingress of moisture within the housing.

2. An arrangement as claimed in claim 1 where the headphones incorporate a connector seal for an electrical port to the player and the storage device.

3. An arrangement as claimed in claim 1 where the audio player and storage device is an MP3 player.

4. An arrangement as claimed in claim 1 where the arrangement comprises a pair of ear piece housings connected by a band to bias in use engagement by the headphones about a user's head.

5. An arrangement as claimed in claim 1 where the housing comprises housing parts secured together along abutting edges.

6. An arrangement as claimed in claim 1 where the peripheral seal engages between the abutting edges.

7. An arrangement as claimed in claim 1 where the peripheral seal comprises a flat washer or O ring.

8. An arrangement as claimed in claim 1 where the peripheral seal is formed from a silicon rubber material.

9. An arrangement as claimed in claim 1 where the abutting edges include a gutter channel for moisture evacuation.

10. An arrangement as claimed in claim 1 where the connector seal comprises a slit flap or doughnut constriction across the electrical port.

11. An arrangement as claimed in claim 10 where the slit flap or doughnut constriction is made from a silicon rubber material.

12. An arrangement as claimed in claim 1 where the loud speaker is waterproof.

13. An arrangement as claimed in claim 1 where the ear piece is coated with a waterproof film or lacquer.

14. An arrangement as claimed in claim 13 where the waterproof film or lacquer is located over seams of the ear piece.

15. An arrangement as claimed claim 1 where the arrangement incorporates button switches having a seal across a button.

16. An arrangement as claimed in claim 15 where the button is a diaphragm button.

17. An arrangement as claimed in claim 1 where an ear phone chassis includes an aperture to allow air pressure balance in use.

18. An arrangement claimed in claim 1 wherein the arrangement includes a band extending from the housing to accommodate at least a part of an audio player or storage device.

19. (canceled)
